(19) United States
(12) Patent Application Publication
(10) Pub. No.: US 2021/0276923 A1
(43) Pub. Date: Sep. 9, 2021

(54) COMPOSITE CERAMIC BODIES AND APPLICATIONS THEREOF

(71) Applicant: Kennametal Inc., Latrobe, PA (US)

(72) Inventor: Jason GOLDSMITH, Greensburg, PA (US)

(21) Appl. No.: 16/703,205

(22) Filed: Dec. 4, 2019

(51) Int. Cl. C04B 35/597

(52) U.S. Cl. CPC C04B 35/597; C04B 2235/3878; C04B 2235/963; C04B 2235/85; C04B 2235/3882

(57) ABSTRACT

In one aspect, ceramic bodies are described herein exhibiting composite architecture. Briefly, a composite ceramic body comprises a bulk region including a mixture of alpha-SiAlON and beta-SiAlON, and a surface region covering the bulk region, the surface region having a residual stress of −500 MPa to 500 MPa and a thickness of at least 5 μm.

### FIELD

The present invention relates to sintered ceramic bodies and, in particular, to sintered SiAlON-based ceramic bodies for various tooling applications.

### BACKGROUND

SiAlON materials have a number of uses including, for example, cutting inserts for various metal cutting applications and wear parts for various wear applications (e.g., plunger rods for pumps, plunger ball blanks, down hole pump check valve blanks, bushings, blast nozzles, and other wear and impact applications). Ceramic materials have also been used in high temperature wear applications in structures such as microturbines. In microturbine applications, the ceramic materials may comprise the stator (i.e., the stationary blades), the rotor (including the rotor blades), the fuel injector nozzle, and/or the shroud. These components of the microturbine require adequate high temperature creep resistance and adequate high temperature deformation resistance. Current SiAlON material are increasingly reaching their performance limits, thereby calling for the development of new ceramic materials

### SUMMARY

In one aspect, ceramic bodies are described herein exhibiting composite architectures. Briefly, a composite ceramic body comprises a bulk region including a mixture of alpha-SiAlON and beta-SiAlON, and a surface region covering the bulk region, the surface region having a residual stress of −500 MPa to 500 MPa and a thickness of at least 5 μm. In some embodiments, the surface region exhibits the foregoing residual stress condition in the as-sintered state. Alternatively, the surface region can be exposed to one or more mechanical surface treatments. Moreover, the composite ceramic body can further comprise an additive phase including metal oxides, metal borides or mixtures thereof.

These and other embodiments are further described in the following detailed description.

### DETAILED DESCRIPTION

Embodiments described herein can be understood more readily by reference to the following detailed description and examples and their previous and following descriptions. Elements, apparatus and methods described herein, however, are not limited to the specific embodiments presented in the detailed description and examples. It should be recognized that these embodiments are merely illustrative of the principles of the present invention. Numerous modifications and adaptations will be readily apparent to those of skill in the art without departing from the spirit and scope of the invention.

As described herein, a ceramic body comprises a bulk region including a mixture of alpha-SiAlON and beta-SiAlON, and a surface region covering the bulk region, the surface region having a residual stress of −500 MPa to 500 MPa and a thickness of at least 5 μm. In some embodiments, the surface region has a thickness of 5-50 μm or 10-30 μm. Thickness of surface region can be dependent on several considerations including, but not limited, to compositional parameters of the powder forming the composite body and sintering conditions, such as sintering times, temperatures and/or atmosphere. Additionally, residual stress of the surface region can have a value selected from Table I.

```
TABLE I
Surface region Residual Stress (MPa)
−200 to 200
−100 to 300
  −50 to 100
50-500
  0-200
  −50 to −400
  −100 to −300
```

As is known to the skilled artisan, a negative value for residual stress indicates the stress is compressive. Conversely, a positive value for residual stress indicates the stress is tensile. The surface region may exhibit residual stress values described herein in the as-sintered state. In being in the as-sintered state, the surface region has not been subjected to any mechanical post-sintering processing to alter the residual stress condition of the layer, such as blasting or polishing. The as-sintered state does include hot isostatic pressing operations performed on the sintered ceramic body. Alternatively, the surface region may exhibit residual stress values described herein after being subjected to one or more mechanical treatments, such as blasting and/or polishing.

Residual stress and shear stress of the surface region are determined by x-ray diffraction using the Chi tilt Sin²ψ method with reference to the (322) reflection of the alpha-SiAlON crystalline phase. Data was collected on a Bragg focusing diffractometer.

### Incidence Optics Included:

Long fine focus X-ray tube operating at 45 KV and 40 MA.
Variable divergence optic operating in automatic mode to insure constant irradiated sample volume throughout the analysis.
Fixed antiscatter slit

### Receiving Optics Included:

Variable Antiscatter slit operating in automatic mode to match the automatic divergence slit Multistrip solid state detector operating in scanning mode.

Scan parameters (speed and count time) are selected to insure a minimum of ten data steps across the peak full width at half max (FWHM) and approximately 10,000 total counts on the most intense peak. Collected data is first converted from variable mode to fixed mode usable for analysis. This conversion is completed using the formula:

$${I}_{FIX} ( θ , a ) = {I}_{A D S} ( θ , L ) \times ( \frac{R sin ( a / 2 )}{L} ) \times ( \frac{1}{sin ( θ + a / 2 )} + \frac{1}{sin ( θ - a / 2 )} )$$

where a=the divergence angle and L=the irradiated length on the sample. The corrected intensity is analyzed using peak finding software to identify the peak position of all peaks in the collected data. The peaks are then refined using a profile function to precisely identify the peak position and peak height.

Peak data was then corrected for Absorption and Transparency using the following equations:

$$Absorption Correction$$

$$A = [ 1 - \frac{tan ( ω - θ )}{tan θ} ] \times [ 1 - {e}^{( - υ t \times \frac{2 sin θ \times cos ( ω - θ )}{{sin}^{2} θ - {sin}^{2} ( ω - θ )} )} ]$$

$$Transparency Correction$$

$$Δ2θ = \frac{180}{π} \times \frac{2 τ}{R} \times \frac{sin ( θ ) cos ( θ )}{sin ( ω )}$$

$$with τ = \frac{t}{β} \times \frac{( 1 - β ) \times {e}^{- β} - {e}^{- β}}{1 - {e}^{- β}}$$

$$and β = \frac{2 μtsinθ \times cos ( ω - θ )}{{sin}^{2} θ - {sin}^{2} ( ω - θ )}$$

where:

t=thickness of layer

μ=linear absorption coefficient (cm⁻¹)

θ=2Theta/2 (degrees)

(ω−θ)=omega offset angle (degrees)

ψ=tilt angle (Psi stress) (degrees)

τ=information depth (microns)

R=Radius of goniometers (mm)

The peak data was corrected for Lorentz polarization using the following equation:

$$Polarization Correction$$

$$L P = \frac{{cos}^{2} 2 {θ}_{mon} \times {cos}^{2} 2 θ}{sin θ}$$

2θₘₒₙ=diffraction angle of graphite monochromator

The Kα₂ peaks were removed using the Ladell model. Peak positions were refined using a Pearson shape profile function.

The residual stress was calculated from the general equation:

$$\frac{{d}_{φψ} - {d}_{0}}{{d}_{0}} = {S}_{1} ( {σ}_{1} + {σ}_{2} ) + \frac{1}{2} {S}_{2} {σ}_{φ} {sin}^{2} ψ$$

where σ_{φ}=σ₁ cos² φ+σ₂ sin² φ
d_{φψ}=lattice constant at angle φ and tilt ψ
dₒ=strain free lattice constant
φ=rotation angle
ψ=specimen tilt
σ₁ & σ₂=primary stress tensors in specimen surface
σ_{φ}=stress at p rotation angle
S₁ & ½ S₂ X-ray elastic constants

$${S}_{1} = \frac{- υ}{E} \frac{1}{2} {S}_{2} = \frac{1 + υ}{E}$$

For the present alpha-SiAlON analysis, Poisson's Ratio (u) was set to 0.2, and the elastic modulus (E in GPa) was 305.

As described herein, the surface region can be subjected to one or more post-sintering treatments. The surface region, for example, can be blasted with various wet and/or dry particle compositions. Surface blasting can be administered in any desired manner. In some embodiments, blasting comprises shot blasting or pressure blasting. Pressure blasting can be administered in a variety of forms including compressed air blasting, wet compressed air blasting, pressurized liquid blasting, wet blasting and steam blasting. Wet blasting, for example, is accomplished using a slurry of inorganic and/or ceramic particles, such as alumina, and water. The particle slurry can be pneumatically projected at a surface of the composite ceramic body. The inorganic and/or ceramic particles can generally range in size between about 20 μm and about 100 μm.

Blasting parameters include pressure, angle of impingement, distance to the part surface and duration. In some embodiments, angle of impingement can range from about 10 degrees to about 90 degrees, i.e., the particles impinge the ceramic surface at an angle ranging from about 10 degrees to about 90 degrees. In some embodiments, suitable pressures can range from 30-55 pounds per square inch (psi) at a distance to the ceramic surface of 1-6 inches. Further, duration of the blasting can generally range from 1-10 seconds or longer. Blasting can be generally administered over the entire surface area of the composite ceramic body or can be applied to select locations such as in a workpiece contact area of the cutting tool. A workpiece contact area can be a honed region of the cutting tool.

In other embodiments, the surface region is subjected to a polishing treatment. Polishing can be administered with paste of appropriate diamond or ceramic grit size. Grit size of the paste, in some embodiments, ranges from 1 μm to 10 μm. In one embodiment, a 5-10 μm diamond grit paste is used to polish the surface of the composite ceramic body. Further, grit paste can be applied to the ceramic body by any apparatus not inconsistent with the objectives of the present invention, such as brushes. In one embodiment, for example, a flat brush is used to apply grit paste to the surface of the composite ceramic body.

The surface region can be blasted or polished for a time period sufficient to achieve a desired surface roughness (Rₐ) and/or residual stress of the surface region. In some embodiments, the surface region subjected to post-coat treatment has a surface roughness (Rₐ) selected from Table II.

TABLE II
Ceramic Body Surface Roughness (Rₐ)
Surface Roughness (Rₐ) - nm
≤700
≤600
≤500
10-500
50-300
25-150

Coating surface roughness can be determined by optical profilometry using WYKO® NT-Series Optical Profilers commercially available from Veeco Instruments, Inc. of Plainview, N.Y. In some embodiments, the surface region can exhibit a surface roughness value described herein in the as-sintered state.

In some embodiments, the surface region can comprise alpha-SiAlON alone or a mixture of alpha-SiAlON and beta-SiAlON. For example, the surface region can be at least 90 weight percent or at least 95 weight percent alpha-SiAlON. In some embodiments, the surface region is 97-99.5 weight percent alpha-SiAlON. The surface region may also further comprise one or more metal oxides and/or metal oxynitrides. Metal oxides and metal oxynitrides of the surface region can comprise one or more metallic elements selected from the group consisting of aluminum, silicon, and metallic elements of Groups IIIB-VIB of the Periodic Table. Surface region metal oxides may also comprise one or more Lanthanide series elements. In some embodiments, for example, the surface region comprises aluminum ytterbium silicon oxynitride in addition to alpha-SiAlON or a mixture of alpha-SiAlON and beta-SiAlON.

Composite ceramic bodies described herein comprise a bulk region in addition to the surface region, the bulk region comprising a mixture of alpha-SiAlON and beta-SiAlON. The bulk region can comprise any amount of alpha-SiAlON and beta-SiAlON not inconsistent with the objectives of the present invention. In some embodiments, the bulk region comprises beta-SiAlON in an amount greater the 60 weight percent or greater than 70 weight percent. The bulk region, for example, can comprise 50 to 90 weight percent beta-SiAlON. The bulk region generally comprises alpha-SiAlON in an amount less than 30 weight percent. In some embodiments, the bulk region comprises alpha-SiAlON in an amount of 5 to 25 weight percent. The bulk region, in some embodiments, comprises alpha-SiAlON in an amount less than 20 weight percent or less than 10 weight percent.

The bulk region can also comprise an additive phase in addition to the beta-SiAlON and alpha-SiAlON phases. The additive phase, in some embodiments, comprises metal oxides, metal nitrides, metal carbides, metal carbonitrides, metal oxynitrides, metal borides, or mixtures thereof. Metallic elements of the oxides, nitrides, oxynitrides, borides, carbides and/or carbonitrides can be selected from the group consisting of aluminum, silicon and metallic elements of Groups IIIB-VIB of the Periodic Table. Metallic elements of the additive phase can also comprise one or more Lanthanide series elements. In some embodiments, the additive phase comprises one or more species selected from Table III.

TABLE III
Additive Phase Species

Y₂O₃
Yb₂O₃
Al₂O₃
MgO
TiO₂
TiN
TiC
TiCN
TiB₂
ZrO₂
BN
B₄C
AlN
MgAl₂O₄
ZrB₂
WC
Hf₂O₃
Ce₂O₃
Nd₂O₃
Sm₂O₃
Er₂O₃
Lu₂O₃
La₂O₃
Gd
Dy
Y₂Si₃N₄O₃

In some embodiments, the additive phase is present at grain boundaries of the alpha-SiAlON and beta-SiAlON. In other embodiments, one or more species of the additive phase can form solid solutions with alpha-SiAlON, beta-SiAlON, or silicon nitride. Additive phase can be present at grain boundary locations and form solid solutions, in some embodiments. The additive phase can be present in the composite ceramic body in any amount not inconsistent with the objectives of the present invention. The additive phase, for example, can generally be present in an amount of 0.1 to 15 weight percent of the composite ceramic body. In some embodiments, the additive phase is present in the composite ceramic body in an amount selected from Table IV.

TABLE IV
Additive Phase (wt. %)
1-5
2-7
3-5
7-15
10-15

Quantitative analyses of the various phases of the composite ceramic body (e.g. alpha-SiAlON, beta-SiAlON, additive) are administered using the Rietveld method. Data is collected using a Bragg diffractometer and processed as set forth above. All phases in the collected pattern are identified and structure data is selected for each phase for the Rietveld analysis. To keep the Rietveld analysis consistent, the same structure data is used for all analyses of the composite ceramic body. The structure data used is taken from the ICDD PDF4 2015 database. For determining phase composition of the bulk, the surface region of the composite ceramic body can be removed by one or more mechanical processes such as grinding. To ensure complete removal of the surface region, the composite ceramic body can be ground to a minimum depth of 100 μm.

Composite ceramic bodies having composition and structure described herein can exhibit Vickers hardness of at least 15.5 GPa. In some embodiments, a composite ceramic body has a hardness of 16-20 GPa. Vickers hardness values are measured using an 18.5 kg load. Composite ceramic bodies described herein may also exhibit a fracture toughness (K_{IC}) of at least 4 MPa·m^{0.5}. In some embodiments, the composite ceramic bodies have a fracture toughness of 4.5 to 8 MPa·m^{0.5} or 6 to 7.5 MPa·m^{0.5}. Fracture toughness values are determined on a polished surface employing a Palmqvist indentation technique using a 18.5 kg load on a Vickers indenter as set forth in Evans and Charles, Fracture Toughness Determination by Indentation, J. American Ceramic Society, Vol. 59, Nos. 7-8, pp. 371-372.

Composite ceramic bodies can be produced by providing powder silicon nitride (Si₃N₄) and any powder additive components, including any of the additive components listed in Table III. The powder components are mixed and pressed into a green compact of desired geometry. Pressing the mixed powder composition into the green compact generally includes an organic binder, such as polyethylene glycol or paraffin wax. The green compact is then sintered under a nitrogen atmosphere for a time period of 45-90 minutes and a temperature of 1800-1850° C. In some embodiments, the sintered compact can be subjected to hot isostatic pressing (HIP) at a temperature of 1825-1875° C. for a duration of 15 minutes to 1 hour. Pressures applied during HIP generally ranging from 10 ksi to 20 ksi. In some embodiments, HIP can be applied during the sintering process.

These and other embodiments are further illustrated in the following non-limiting examples.

### Example 1—Composite Ceramic Body

A powder mixture comprising 3 weight percent MgO, 3 weight percent Y₂O₃, and the balance Si₃N₄ was pressed into compacts having ANSI geometry CNMX334T0820SB4. The green compacts were sintered at 1800° C. under a nitrogen atmosphere for a time period of one hour, followed by HIP under an argon atmosphere at 1850° C. for a time period of one hour. The resulting sintered composite ceramic bodies included a surface region having thickness of 5-20 μm and comprising at least 97 weight percent alpha-SiAlON with the remainder beta-SiAlON. The surface region exhibited tensile stress of 250-300 MPa in the as-sintered state. Additionally, the bulk region included beta-SiAlON in an amount greater than 70 weight percent with the remainder alpha-SiAlON (17-20 weight percent) and additive phase (5-7 weight percent). The sintered composite ceramic bodies exhibited a Vickers hardness of 15.9-16.5 GPa and fracture toughness of 6.6 to 7.2 MPa·m^{0.5}.

### Example 2—Metal Cutting Testing

A composite ceramic body according to Example 1 was subjected to continuous turning testing according to the parameters below. A Comparative sintered ceramic body of the same tool geometry was also subjected to the continuous turning testing. The Comparative ceramic body consisted of 100 weight percent beta-SiAlON. The Comparative ceramic body was sourced from a grade exhibiting Vickers hardness of 15.4 to 15.6 GPa and fracture toughness of 5.6 to 6 MPa·m^{0.5}.

### Turning Parameters

Workpiece: Class 30 GCI30 Tubes (w/OD scale)

### Speed: 3000 sfm

### Feed Rate: 0.012 ipr

### Depth of Cut: 1.5 mm

### Lead Angle: −5°

The results of the continuous turning testing are provided in Table V.

TABLE V
Continuous Turning Testing Results

| Ceramic Body | Lifetime (min) |
|---|---|
| Comparative 1 | 5.9 |
| Example 1 | 7.8 |

The composite ceramic body of Example 1 exhibited at 32 percent increase in cutting lifetime relative to the Comparative ceramic body.

Various embodiments of the invention have been described in fulfillment of the various objects of the invention. It should be recognized that these embodiments are merely illustrative of the principles of the present invention. Numerous modifications and adaptations thereof will be readily apparent to those skilled in the art without departing from the spirit and scope of the invention.

1. A composite ceramic body comprising:
a bulk region comprising a mixture of alpha-SiAlON and beta-SiAlON; and
a surface region covering the bulk region, the surface region comprising a mixture of alpha-SiAlON and beta-SiAlON and having a residual stress of −100 MPa to 300 MPa and a thickness of at least 5 μm, wherein the composite ceramic body is in the as-sintered state.

2. The composite ceramic body of claim 1, wherein alpha-SiAlON is present in the surface region in an amount greater than 95 weight percent of the surface region.

3. The composite ceramic body of claim 1, wherein alpha-SiAlON is present in the surface region in an amount greater than 98 weight percent of the surface region.

4. The composite ceramic body of claim 1, wherein the bulk region comprises beta-SiAlON in an amount greater than 70 weight percent.

5. The composite ceramic body of claim 1, wherein the surface region comprises mixed metal oxide.

6. The composite ceramic body of claim 1, wherein the bulk region comprises less than 20 weight percent alpha-SiAlON.

7. The composite ceramic body of claim 1, wherein the bulk region further comprises an additive phase comprising metal oxides, metal oxynitrides, metal borides or mixtures thereof.

8. The composite ceramic body of claim 7, wherein the metal oxides, metal oxynitrides, and metal borides comprise one or more metallic elements selected from the group consisting of aluminum, silicon and metallic elements of Groups IIIB-VIB of the Periodic Table.

9. The composite ceramic body of claim 8, wherein the metal oxides comprise one or more Lanthanide series elements.

10. The composite ceramic body of claim 7, wherein the additive phase comprises Y₂Si₃N₄O₃.

11. The composite ceramic body of claim 7, wherein the additive phase is located at SiAlON grain boundaries.

12. The composite ceramic body of claim 7, wherein the additive phase forms one or more solid solutions with alpha-SiAlON, beta-SiAlON, or silicon nitride.

13. The composite ceramic body of claim 7, wherein the one or more additive phase is present in an total amount of 0.1 to 15 weight percent.

14. The composite ceramic body of claim 7, wherein the additive phase is present in an amount of 2-5 weight percent.

15. The composite ceramic body of claim 1, wherein the surface region has a Vickers hardness of at least 15.5 GPa.

16. The composite ceramic body of claim 1, wherein the bulk region has a fracture toughness of at least 4.5 MPa·m^{0.5}.

17. The composite ceramic body of claim 1 having a surface roughness of less than 600 nm.

18. The composite ceramic body of claim 1 having a surface roughness of 300-600 nm.
